(19) United States
(12) Patent Application Publication
(10) Pub. No.: US 2004/0093295 A1
(43) Pub. Date: May 13, 2004

(54) Retail distributive computing

(75) Inventor: Robert J. Burnett, Dakota Dunes, SD (US)

Correspondence Address: GATEWAY, INC., ATTN: SCOTT CHARLES RICHARDSON, 610 GATEWAY DR., Y-04, N. SIOUX CITY, SD, 57049, US

(73) Assignee: Spotware Technologies, Inc.

(21) Appl. No.: 10/293,621

(22) Filed: Nov. 13, 2002

(51) Int. Cl. G06F 17/60

(52) U.S. Cl. 705/36

(57) ABSTRACT

The present invention is directed to a system and method for providing distributive computing resources in a retail environment. The system and method of the present invention take advantage of the distributive computing power of retail computing resources, such as demonstration and training computers.

### FIELD OF THE INVENTION

The present invention generally relates to the field of distributive computing and particularly to a method for distributive computing in a retail environment.

### BACKGROUND OF THE INVENTION

Distributive computing services permit large scale computing project which would normally occur on a dedicated server to be distributed among a larger number of less powerful computing resources such as personal computers. One incentive to distributing the computing load among a large number of computers, such as desktop computers, is the frequent occurrence of downtime when less powerful, but more prevalent computers do not fully utilize their processing capability. For example, personal computers often are left on standby mode, or allowed to go to sleep when the user is not interacting with the computer. Distributive computing offers an alternative to enterprise level computing.

Distributive computing also benefits from the economic advantage of utilizing inexpensive, multiple low power computers, in comparison to an expensive high powered enterprise-level server. In addition to the high cost associated with obtaining a server are maintenance costs, such as technicians, downtime and overhead costs such as facilities and the like. Economic factors generally increase the overall cost of maintaining in-house servers capable of handling processing demands. Distributive computing systems offer a lower cost alternative to meet an organization's data handling needs.

While distributive computing is an economically attractive option to in-house server computing needs, the drawbacks experienced with distributive computing often weigh in favor of purchasing a server. For instance, paramount to any distributive computing system is security. To take advantage of distributive computing companies often utilize their internal computers, such as desktops, to carry-out data handling. Internal distributive computing may be feasible for large business, but some organizations do not have sufficient resources to implement internal distributive computing. In such instances, data handling is typically transferred to an outside provider. Organizations utilizing external distributive computing may be vulnerable to computer hacking from external sources as data is transferred. Individuals or organizations participating in distributive computing may attempt to access, interfere, or even sabotage data. Thus, distributive computing for business is especially vulnerable to industrial espionage.

Another drawback to distributive computing is the disparity in computing resources and connectivity. The logistics of establishing a distributive computing system can raise entry costs, thus making a distributive computing system less desirable. For instance, distributive computing resources and connectivity may vary. When individual computer owners participate the overall computing power and connectivity may vary greatly. For example, some owners may have old computers which are of marginal value to the overall system or have slow, error prone connections, which cause difficulties.

Furthermore, with large number owners involved, the distributive system is susceptible to swings in computing power. The ability to complete a task may vary if a large number of owners switch off their systems. Computing difficulties lead to customer dissatisfaction when deadlines cannot be accommodated. Moreover, a distributive computer system may experience higher levels of technical difficulties when a large number of computer owners are involved. Technical difficulties decrease productivity and lead to increased cost.

Additionally, potential distributive computing resource providers, such as individuals may, resist or not participate if the overall system is capable of monitoring computing habits. For example, a distributive system may be implemented most efficiently if the system is able to monitor when a particular resource is used, so that the system may predict or monitor when the resource is available for distributive computing tasks. In another example, the distributive computing system requires resources to carry out a task, but when the system attempts to distribute the task the distributive device is unable to establish communication with individual computing resources due to the system being turned-off.

Therefore, it would be desirable to provide a system and method for utilizing retail computers for distributive computing.

### SUMMARY OF THE INVENTION

Accordingly, the present invention is directed to a system and method for utilizing retail computing resources to provide distributive computing services for commercial applications.

In a first aspect of the invention, a system for retail distributive computing includes a server for distributing the client task. A plurality of retail computing resources are coupled to the sever via a network. Each individual computing resource includes a memory and a processor. The processors of the resources are programmed to cause the processors to monitor for processor availability, report processor availability to the server and process the distributed task if the processor has available processing power.

In a second aspect of the present invention, a method for retail distributive computing includes monitoring an individual computing resource for processor availability. The individual computing resources receive distributive computing requests from the server. The individual computing resources process the received request if the individual resource has excess processing power. Subsequently, the processed task is transferred to the sever.

In a further aspect of the invention, a method for selling computing resources includes distributing a processing task to individual computers with available processing capacity. Individual computer resources process the task if the resource has excess capacity. If the processor is interrupted by a retail computer user, the computing task may be stored in the hard drive. Once processed, the task is assembled by the server into the complete task. Finally, a bill is generated based on utilized computing resources.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a distributive computing system for utilization in a retail environment in an embodiment of the present invention;

FIG. 2 is a flow diagram of an exemplary method for providing distributive retail computing; and

FIG. 3 is a flow diagram of an exemplary method for providing distributive retail computing including billing for processor utilization.

### DETAILED DESCRIPTION OF THE INVENTION

Reference will now be made in detail to the presently preferred embodiments of the invention, examples of which are illustrated in the accompanying drawings.

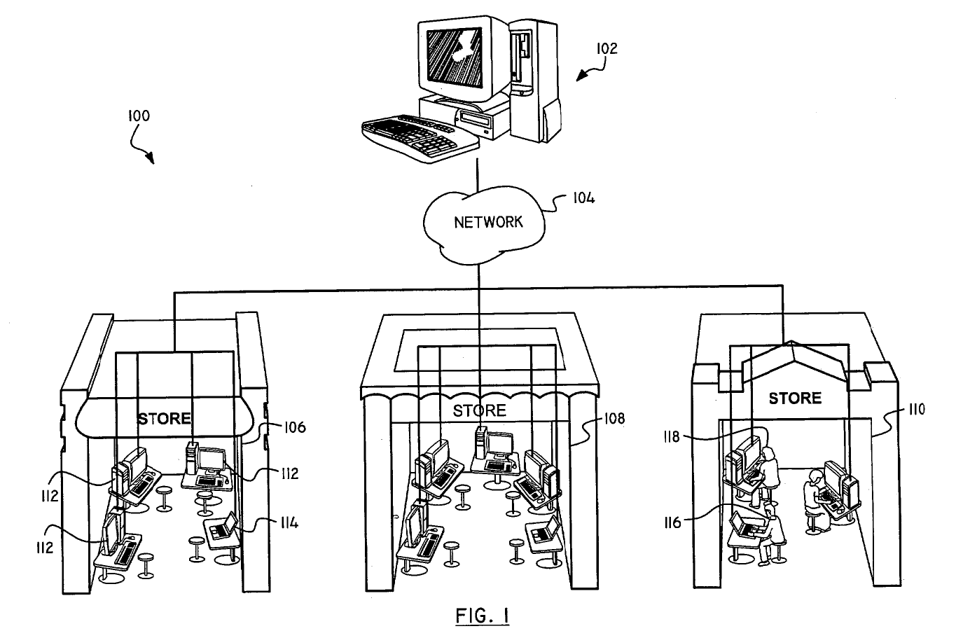

Referring generally now to FIGS. 1 through 3, exemplary embodiments of the present invention are shown wherein a system and method for providing retail distributive computing is discussed. Distributive computing previously was limited to distributive systems internal to large organizations, such as corporations and to philanthropic projects where computing resource were provided to achieve altruistic goals. Moreover, drawbacks experienced with distributive computing systems limited their functionality and failed to provide sufficient economic incentive for commercial use.

Previously, distributive computing services failed to provide secure, reliable computing, therefore businesses often relied on other alternatives to meet their computing needs. The system and method of the present invention utilizes retail computers, such as demonstration computers and customer training computers, including desktops, laptops and the like commonly available at retail outlets, such as computer stores and computer manufacturer training facilities to provide state of the art reliable distributive computing services. Because these computing resources serve additional functions, such as marketing and training, the distributive computing capability increases utility and economic efficiency.

Referring to FIG. 1, a system 100 for providing commercial distributive computing resources is discussed. The system 100 of the present invention takes advantage of the processing ability of retail computers including demonstration computers, training computers, such as desktop computers, laptops and the like to provide secure, reliable computing power. A server 102 is included in the system 100. The server 102 in the present embodiment acts to parse or distribute the client computing task among the computing resources in the system 100. Additionally, the server 102 is capable of assembling the processed task for transfer to the client. Computing tasks include data handling, web hosting, and the like.

In a further aspect of the invention, the server 102 is capable of generating a bill based on the amount of computing resources utilized to complete the task. For example, the server 102 may generate a bill based on the amount of processing required for the task on a per use basis.

A plurality of computing resources are coupled to the server 102 via a network 104. For example, the network 104 may be a wide area network (WAN), a local area network (LAN), the Internet and the like for transferring data among the server 102 and computing resources at various retail locations, such as retail locations “1-3” shown 106, 108 & 110 in FIG. 1. The connection may be made over a dedicated line, and/or encrypted to further promote security, if desired. Moreover, the system 100 of the present invention may take advantage of high bandwidth connections already in place for retail purposes, such as demonstrating Internet access.

Retail computing resources include desktop computers disposed in retail environments, such as computer stores and training centers. Retail computing resources are advantageous because such computing systems tend to be the newest machines with high levels of computing power and data storage capability. Thus, collectively the computing resources in the system 100 offer efficient processing power and high-speed data transfer capabilities between locations and the server 102. Moreover, due to the nature of computer retailing highly trained technicians are readily available at marginal cost in the event of a problem and/or to monitor access for signs of hacking.

The distributive computing task may be conducted as a private task on the computing resources. The distributive computing capability may be installed as part of a software package which is unobservable or not readily observable by a user. The private task may initiate when the computing resource is unused or underutilized depending on the specific implementation. For example, when a user interacts with the computing resource, such as user 116 with a desktop, the distributive computing task is reduced, halted and the like depending on the user activity.

Furthermore, software for conducting distributive computing functions may monitor central processor unit (CPU) activity to initiate distributive processing and/or to report to the server 102 the resource's availability to conduct distributive tasks. In additional embodiments, individual computing resources and/or the server is capable of predicting processing availability. For example, the server includes software capable of predicting individual resource availability, such as that all the resources at retail location “3” 110 are busy at a particular time due to a training class.

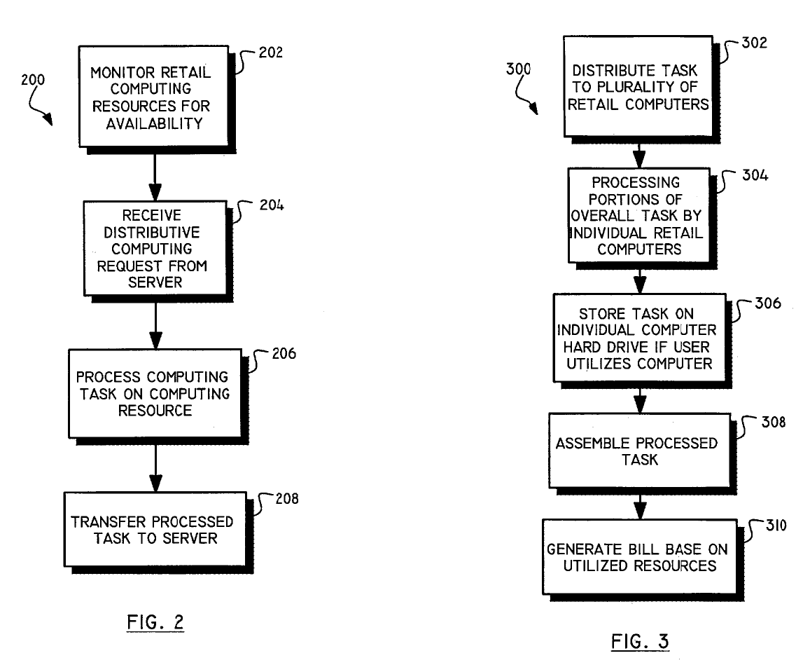

Referring to FIG. 2 a method 200 for providing retail distributive computing is discussed. The present method may occur so as to remain hidden or not readily observable by retail computing resource users. Individual retail computers of a plurality of retail computers, such as demonstration computers including desktop computers, laptop computers and the like, is monitored 202 for CPU activity/user interaction. Monitoring may include monitoring processor activity and user interaction by private software installed on the individual resource. In further embodiments, monitoring may be conducted by server software. When individual computing resources are monitored by the distributive computing software, the individual computing systems may additionally report processor activity, user interactions and the like to the sever.

Based on monitored processor availability, a distributive computing request is received 204 by the plurality of retail computers from the server. For instance, the request requires the resource process a portion of the overall computing task. Moreover, the task assigned may be based on the resource's processing capability, the length of time the resource is inactive, predicted use and the like. For example, based on monitoring, the distributive task software determines that the resource is idle from 12:00 p.m. to 1:00 p.m., therefore the resource receives a one hour task.

The computing resources proceed to process 206 the received task. Processing occurs if the resource has excess processing capability. For example, if the computer is not actively engaged or if users are not interacting with the computer. The distributed computing task may be stored in a portion of the resource's hard drive, if the processor is interrupted, if large amounts of data are received or generated as part of the task.

The processed task is transferred 208 to the sever. Transferring and receiving the task between the computing resources and the server may occur over a LAN, WAN, the Internet, a dedicated connection and the like. Upon completion of the task the sever may generate a bill corresponding the amount of computing resources required to complete the task.

Referring to FIG. 3 a method for selling computing resources is described. The process is initiated with the distribution 302 of a data processing task, such as data handling, web hosting or the like to a plurality of retail computers. For instance, the task is distributed to demonstration computers in a computer store. The computing task may be distributed based on individual retail computer processor availability, such as whether the computer is actively processing data. Distribution of the task may occur over a dedicated connection, the Internet and the like. Further, in implementations of the present method processing task distribution is encrypted to maximize security.

Individual retail computers process the task 304. Each retail computer process the portion of the task which is distributed by the server. Processing continues while the system has excess processing power.

In the event a user interacts with the computer, the distributive processing task is reduced or halted. If the task is halted, such as due to the computer being utilized the computing task is stored 306 on the computer's hard drive. Once the computer is idled, distributive processing may occur. In further embodiments, halted computing resources may notify the server so that the individual task may be retasked to an available resource.

The server assembles 308 the processed task. The server assembles the overall task from the individual tasks carried out on each of the computing resources of the plurality of participating retail computers. Assembling may include any additional data processing required to complete the task.

Once the task is assembled 308, a bill is generated 310. In the present embodiment, the bill is based on the amount of computing resources required to complete the task. For instance, the bill is based on the time and processing power utilized to complete the client's task.

An alternative use of the distributed resources is to store data in the permanent storage, e.g. hard disk drives of the distributive computers. For instance, much of the storage on a demonstration machines is unused. The distributive server can be directed to store data on distributive computers and to bill the client appropriately.

Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

It is believed that the system and method of the present invention and many of is attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for retail distributive computing, comprising:
a sever capable of distributing a computing task;
a network; and
a plurality of retail computing resources coupled to the server via the network, wherein an individual computing resource of the plurality of retail computing resources includes:
a memory capable of storing a program of instructions;
a processor coupled to the memory, capable of executing the program of instructions wherein the program of instructions causes the processor to:
monitor the processor for availability;
report processor availability to the server; and
process the distributed task, if the processor has excess capacity;
wherein the system distributes a computing task to the plurality of retail computing resources for data processing.

2. The system for retail distributive computing, of claim 1, wherein the network is the Internet.

3. The system for retail distributive computing, of claim 1, wherein the network at least one of a wide area network (WAN) and a local area network (LAN).

4. The system for retail distributive computing, of claim 1, wherein the plurality of retail computing resources are retail demonstration computers.

5. The system for retail distributive computing, of claim 1, wherein the distributive computing task is hidden from the retail computing resource user.

6. The system for retail distributive computing, of claim 1, wherein distributive computing tasking request is based on at least one of monitored retail computer resource usage and predicted retail computer resource availability.

7. The system for retail distributive computing, of claim 1, wherein the sever calculates a bill based on computer resource usage.

8. The system for retail distributive computing, of claim 1, wherein the computing task is web hosting.

9. The system for retail distributive computing, of claim 1, wherein the retail computing resources are disposed in disparate retail locations.

10. The system for retail distributive computing, of claim 1, wherein the retail computing resource further includes: a storage device for storing data.

11. A method for retail distributive computing using idle retail computing resources, comprising the steps of:
monitoring individual retail computing resources for processor availability;
receiving a distributive computing request from a server by a plurality of retail computing resources;
processing the received portion of the distributive computing task on an individual retail computing resource of the plurality of retail computing resources, if the retail computing resource processor has excess processing capability; and
transferring the processed portion of the distributive computing task to the server.

12. The method for retail distributive computing of claim 11, wherein the distributive computing request is sent to an individual retail computing resource of the plurality of retail computing resources based on reported processor activity.

13. The method for retail distributive computing of claim 11, wherein the distributive computing request is sent to an individual retail computing resource of the plurality of retail computing resources based on predicted processor activity.

14. The method for retail distributive computing of claim 11, wherein requesting and transferring occurs over a dedicated connection.

15. The method for retail distributive computing of claim 11, wherein requesting and transferring occurs over the Internet.

16. The method for retail distributive computing of claim 11, wherein the distributive computing request is stored in unused individual retail computing resource hard drive space until processed.

17. The method for retail distributive computing of claim 11, wherein processing occurs on retail demonstration computers.

18. The method for retail distributive computing of claim 11, wherein the method is hidden from retail computer resource users.

19. The method for retail distributive computing of claim 11, further comprising calculating a bill based on computer resource usage.

20. The method for retail distributive computing of claim 11, wherein the computing task is web hosting.

21. The method for retail distributive computing of claim 11, further comprising the step of storing at least one of processed and unprocessed data on an individual retail computing resource.

22. A method for selling computing resources, comprising:
distributing a data processing task to a plurality of retail computers based on individual retail computer processor availability;
processing at least a portion of the distributed task by an individual retail computer;
storing the processing task on an individual retail computer hard drive, if the a user utilizes the retail computer;
assembling the processed task from the plurality of retail computers; and
generating a bill based on utilized computing resources.

23. A method for selling computing resources of claim 21, wherein the distributed processing task is sent to an individual retail computer of the plurality of retail computers based on reported processor activity.

24. A method for selling computing resources of claim 21, wherein distribution occurs over a dedicated connection.

25. A method for selling computing resources of claim 21, wherein distribution occurs over the Internet.

26. A method for selling computing resources of claim 21, wherein processing occurs on retail demonstration computers.

27. A method for selling computing resources of claim 21, wherein the method is hidden from retail computer users.

28. A method for selling computing resources of claim 21, further comprising the step of storing data on at least one retail computer for a fee.
